(19) United States
(12) Patent Application Publication
(10) Pub. No.: US 2024/0207664 A1
(43) Pub. Date: Jun. 27, 2024

(54) PREPARATION AND USE OF A FOAM STABILIZING COMPOSITION INCLUDING A SILANE SURFACTANT

(71) Applicant: Dow Silicones Corporation, Midland, MI (US)

(72) Inventors: Anirudha Banerjee, Midland, MI (US); Zachary Wenzlick, Midland, MI (US); Nanguo Liu, Midland, MI (US); Kenneth E. Zimmerman, Midland, MI (US)

(21) Appl. No.: 18/556,485

(22) PCT Filed: Jul. 11, 2022
(86) PCT No.: PCT/US2022/073583

§ 371 Date: Oct. 20, 2023

Related U.S. Application Data
(60) Provisional application No. 63/226,246, filed on Jul. 28, 2021.

(51) Int. Cl. A62D 1/02; A62C 5/02

(52) U.S. Cl. CPC A62D 1/0071; A62C 5/02

(57) ABSTRACT

A foam stabilizing composition includes a silane surfactant, a nonionic surfactant, a zwitterionic surfactant, and water. The foam stabilizing composition is useful for preparing a firefighting foam.

### CROSS-REFERENCE TO RELATED APPLICATIONS

This application claims the benefit of U.S. Provisional Patent Application Ser. No. 63/226,246 filed on 28 Jul. 2021 under 35 U.S.C. § 119 (e). U.S. Provisional Patent Application Ser. No. 63/226,246 is hereby incorporated by reference.

### FIELD

A foam stabilizing composition and method for its preparation are provided. The foam stabilizing composition is suitable for use in forming an aqueous foam that can be used for firefighting applications.

### INTRODUCTION

Aqueous foams are highly effective for extinguishing class B (flammable liquid) fires, and have been used for this purpose for 40 to 50 years. The active ingredient in most aqueous foam used for firefighting is a perfluoroalkyl surfactant. An aqueous foam made with the perfluoroalkyl surfactant can smother a fire with a knockdown time (i.e., the time required to completely extinguish the fire) of less than 30 seconds. Additionally, once the fire is extinguished, the aqueous foam made with the perfluoroalkyl surfactant can prevent the fire from reigniting.

Due to many of the desired properties such as high chemical resistance, high hydrophobicity, and high lipophobicity, perfluoroalkyl substances (PFAS) have found wide-spread use. However, PFAS such as perfluoroalkyl surfactants, have been shown to decompose or otherwise degrade under environmental conditions to give numerous fluorochemicals, some of which have been found to be environmentally persistent. As such, PFAS are increasingly being phased out of production and use, leading to many widely utilized perfluoroalkyl surfactants and compositions containing them becoming unavailable for continued use.

Firefighting foam formulators have so far not identified a PFAS-free product that can deliver the same performance in fighting fires as the benchmark aqueous foam containing perfluoroalkyl surfactants. The PFAS-free products on the market are either too slow to spread on fire, or the foams are not stable long enough over the fuel to allow effective fire extinction. Some foams that work over fuel oil are not suitable for firefighting applications involving flammable solvents such as alcohols.

There is an industry need to provide firefighting foam, which are free of PFAS. More particularly, there is an industry need for a firefighting foam that is PFAS-free and stable.

### SUMMARY

A foam stabilizing composition and method for its preparation are provided herein. The foam stabilizing composition comprises: (A) a nonionic surfactant, (B) a zwitterionic surfactant, (C) a silane surfactant, and (D) water. A firefighting foam comprising the foam stabilizing composition, and methods for preparation and use of the firefighting foam, are also provided.

### DETAILED DESCRIPTION

The foam stabilizing composition (composition) introduced above may comprise at least 0.5 weight parts of (A) the nonionic surfactant; at least 0.5 weight parts of (B) the zwitterionic surfactant, at least 0.5 weight parts of (C) the silane surfactant, and up to 98.5 weight parts of (D) water. The foam stabilizing composition may optionally further comprise an additional starting material, which may be selected from the group consisting of (E) a carrier vehicle other than water, (F) a rheology modifier, (G) a pH control agent, (H) a foam enhancer, and a combination of two or more of (E) to (H). The starting materials for preparing the composition are described in detail below.

### (A) Nonionic Surfactant

Some suitable nonionic surfactants which can be used include polyoxyethylene alkyl ethers (such as, lauryl, cetyl, stearyl or octyl), polyoxyethylene alkyl phenol ethers, alkylglucosides, polyoxyethylene fatty acid esters, sorbitan fatty acid esters, polyoxyethylene sorbitan fatty acid esters, polyoxyethylene sorbitan monooleates, polyoxyethylene alkyl esters, polyoxyethylene sorbitan alkyl esters, polyethylene glycol (such as polyethylene glycol having 23 ethylene-oxide units), polypropylene glycol, diethylene glycol, and ethoxylated trimethylnonanols. Nonionic surfactants which are commercially available include compositions such as (i) 2,6,8-trimethyl-4-nonyloxy polyethylene oxyethanols (6EO) and (10EO) sold under the names TERGITOL™ TMN-6 and TERGITOL™ TMN-10; (ii) the C11-15 secondary alkyl polyoxyethylene ethers (e.g., C₁₁₋₁₅ secondary alcohol ethoxylates 7EO, 9EO, and 15EO sold under the names TERGITOL™ 15-S-7, TERGITOL™ 15-S-9, and TERGITOL™ 15-S-15), other C₁₁₋₁₅ secondary alcohol ethoxylates sold under the tradenames ECOSURF™ EH-40 and TERGITOL™ 15-S-12, TERGITOL™ 15-S-30, and TERGITOL™ 15-S-40, by TDCC; octylphenyl polyoxyethylene (40) ether sold under the name TRITON™ X405 by TDCC; (iii) nonylphenyl polyoxyethylene (10) ether sold under the name MAKON™ 10 by the Stepan Company; (iv) ethoxylated alcohols sold under the name Trycol 5953 by Henkel Corp./Emery Group, of Cincinnati, Ohio, USA; (v) ethoxylated alcohols sold under the name BRIJ™ L23 and BRIJ™ L4 by Croda Inc. of Edison, New Jersey, USA, (vi) polyoxyethylene 23 lauryl ether (Laureth-23) sold commercially under the trademark BRIJ™ 35L by ICI Surfactants, Wilmington, Delaware; and RENEX™ 30, a polyoxyethylene ether alcohol sold by ICI Surfactants, Wilmington, Delaware, USA; (vii) alkyl-oxo alcohol polyglycol ethers such as GENAPOL™ UD 050, and GENAPOL™ UD110, (viii) alkyl polyethylene glycol ether based on C10-Guerbet alcohol and ethylene oxide such as LUTENSOL™ XP 79, and (ix) alkyl polyglycosides, such as those sold under the trade name Glucopon™ by BASF, and alkyl glucosides such as decyl glucoside, lauryl glucoside, and coco-glucoside, which are sold under the trade name EcoSense™ by TDCC.

Suitable nonionic surfactants also include poly(oxyethylene)-poly(oxypropylene)-poly(oxyethylene) tri-block copolymers. Poly(oxyethylene)-poly(oxypropylene)-poly(oxyethylene) tri-block copolymers are also commonly known as Poloxamers. They are nonionic triblock copolymers composed of a central hydrophobic chain of polyoxypropylene (poly(propylene oxide)) flanked by two hydrophilic chains of polyoxyethylene (poly(ethylene oxide)). Poly(oxyethylene)-poly(oxypropylene)-poly(oxyethylene) tri-block copolymers are commercially available from BASF of Florham Park, New Jersey, USA, and are sold under the tradename PLURONIC™, such as PLURONIC™ L61, L62, L64, L81, P84.

The nonionic surfactant may also comprise a silicone polyether (SPE). The SPE may have a rake type structure wherein the polyoxyethylene or polyoxyethylene-polyoxypropylene copolymeric units are grafted onto the siloxane backbone, or the SPE can have an ABA block copolymeric structure wherein A represents the polyether portion and B the siloxane portion of an ABA structure. Alternatively, the SPE may have a resinous structure, such as a polyorganosilicate resin having polyether groups bonded to silicon atoms therein. Suitable SPE's include DOWSIL™ OFX-5329 Fluid from DSC. Alternatively, the nonionic surfactant may be selected from polyoxyalkylene-substituted silicones, silicone alkanolamides, silicone esters and silicone glycosides. Such silicone-based surfactants may be used to form such aqueous emulsions and are known in the art, and have been described, for example, in U.S. Pat. No. 4,122,029 to Gee et al., U.S. Pat. No. 5,387,417 to Rentsch, and U.S. Pat. No. 5,811,487 to Schulz et al. Other SPE surfactants are known in the art and are also commercially available, e.g., DOWSIL™ 502W and DOWSIL™ 67 Additive are commercially available from DSC.

Alternatively, the nonionic surfactant may comprise a polyvinyl alcohol compound. Polyvinyl alcohol compounds are known in the art and are disclosed, for example in U.S. Patent Application Publication 2007/0099007 at paragraphs [0172] and [0173]. Polyvinyl alcohol compounds may be made by saponification of polyvinylacetate, so up to 15% of polyvinylacetate may remain in the polyvinyl alcohol compound used herein. Alternatively, the polyvinyl alcohol compound may be 88% to 92% polyvinyl alcohol (with the balance being 12% to 8% polyvinylacetate). The polyvinyl alcohol compound may have a minimum viscosity of 5 cP at 4% aqueous solution at 20° C.

One skilled in the art would recognize that one nonionic surfactant may be used. Alternatively, two or more nonionic surfactants may be used in combination, provided that the silane surfactants differ in at least one property such as type, structure, and/or molecular weight. The composition comprises an amount of the nonionic surfactant ≥0.5 weight part, per up to 100 weight parts of the composition. Alternatively, the composition may comprise at least 0.5 weight part, alternatively at least 0.6 weight part, alternatively at least 0.7 weight part, alternatively at least 0.8 weight part, alternatively at least 0.9 weight part, and alternatively at least 1 weight part, of the nonionic surfactant, while at the same time, the amount may be up to 2 weight parts, alternatively up to 1.9 weight parts, alternatively up to 1.8 weight parts, alternatively up to 1.7 weight parts, alternatively up to 1.6 weight parts, and alternatively up to 1.5 weight parts, of the nonionic surfactant on the same basis above. Alternatively, the composition may comprise 0.5 weight part to 2 weight parts of the nonionic surfactant, per up to 100 weight parts of the composition.

### (B) Zwitterionic Surfactant

Starting material (B) in the composition is a zwitterionic surfactant. Examples of zwitterionic surfactants include amino acid surfactants, betaines (e.g., lauryl betaine, bis-(2-hydroxyethyl) tallow betaine, cocamidopropylbetaine, N-alkylamidobetaines, and derivatives thereof), proteins and derivatives thereof, glycinates (glycine derivatives, such as cocamphglycinate, cocamphocarboxy-glycinates, and cocamphodipropionate), sultaines (e.g., cocamidopropylhydroxysultaine and lauryl sultaine), alkyl aminopropionates, alkyl polyaminocarboxylates and alkylamphoacetates, lecithin and hydrogenated lecithin, and combinations thereof. These surfactants may are commercially available from various suppliers under different tradenames. For example, REWOTERIC™ AM TEG is produced by Evonik of Essen, Germany; AMPHOSOL™ CG is available from Stepan Company of Northfield, Illinois, USA.

One skilled in the art would recognize that one zwitterionic surfactant may be used. Alternatively, two or more zwitterionic surfactants may be used in combination, provided that the zwitterionic surfactants differ in at least one property such as structure and/or molecular weight. The composition comprises an amount of the zwitterionic surfactant ≥0.5 weight part, per up to 100 weight parts of the composition. Alternatively, the composition may comprise at least 0.5 weight part, alternatively at least 0.6 weight part, alternatively at least 0.7 weight part, alternatively at least 0.8 weight part, alternatively at least 0.9 weight part, and alternatively at least 1 weight part, of the zwitterionic surfactant, while at the same time, the amount may be up to 2 weight parts, alternatively up to 1.9 weight parts, alternatively up to 1.8 weight parts, alternatively up to 1.7 weight parts, alternatively up to 1.6 weight parts, and alternatively up to 1.5 weight parts, of the zwitterionic surfactant on the same basis above. Alternatively, the composition may comprise 0.5 weight part to 2 weight parts of the zwitterionic surfactant, per up to 100 weight parts of the composition.

### (C) Silane Surfactant

Starting material (C) in the composition is a silane that differs from starting materials (A) and (B). The silane surfactant has formula

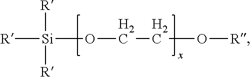

where subscript x is an integer with an average value ≥1; R″ is an alkyl group of 1 to 6 carbon atoms or an aryl group of 6 to 20 carbon atoms, and each R′ is independently selected from the group consisting of an alkyl group of 1 to 6 carbon atoms or a group of formula

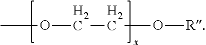

Alternatively, the silane surfactant may have formula

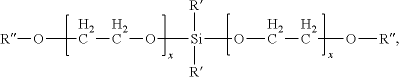

where R″, R′ and subscript x are as introduced above and described below.

In the formulas above, suitable alkyl groups for R′ and R″ include methyl, ethyl, propyl (including n-propyl and isopropyl), butyl (including n-butyl, isobutyl, tert-butyl and sec-butyl, and hexyl (including branched and linear isomers of 6 carbon atoms). Suitable aryl groups for R″ include phenyl, tolyl, and xylyl. Alternatively, each R″ may be alkyl, such as methyl. Alternatively, each R′ may be alkyl, such as methyl.

Each subscript x is independently an integer with an average value of at least 1, alternatively at least 6, alternatively at least 10, and alternatively at least 12, while at the same time each subscript x may have an average value up to 30, alternatively up to 24, alternatively up to 22, and alternatively up to 18. Alternatively, subscript x may have an average value of 6 to 30, alternatively 12 to 24, and alternatively 18. Alternatively, subscript x may be 10 to 12, or subscript x may be 22 to 24. Alternatively, different instances of subscript x may have different values in the ranges described above.

The silane surfactant may have a molecular weight of 500 g/mol to 3000 g/mol; alternatively 1000 g/mol to 2500 g/mol; alternatively 500 g/mol to 2000 g/mol. Alternatively, the silane surfactant may have a molecular weight of at least 500 g/mol, alternatively at least 1000 g/mol, alternatively at least 1200 g/mol, and alternatively at least 1500 g/mol, while at the same time the silane surfactant may have a molecular weight up to 3000 g/mol, alternatively up to 2500 g/mol, alternatively up to 2100 g/mol, and alternatively up to 1500 g/mol.

Silane surfactants and methods for their preparation are known in the art, see for example, U.S. Pat. No. 5,326,557 and the references cited therein. One skilled in the art would recognize that one silane surfactant may be used. Alternatively, two or more silane surfactants may be used in combination, provided that the silane surfactants differ in at least one property such as structure and/or molecular weight. Silane surfactants are commercially available, for example, DOWSIL™ 2501 Cosmetic Wax is available from DSC. The amount of the silane surfactant in the composition is ≥0.5 weight part, per up to 100 weight parts of the composition. Alternatively, the composition may comprise at least 0.5 weight part, alternatively at least 0.6 weight part, alternatively at least 0.7 weight part, alternatively at least 0.8 weight part, alternatively at least 0.9 weight part, and alternatively at least 1 weight part, of the silane surfactant, while at the same time, the amount may be up to 5.5 weight parts, alternatively up to 5.1 weight parts, alternatively up to 5 weight parts, alternatively up to 4.5 weight parts, alternatively up to 4 weight parts, and alternatively up to 3.5 weight parts, and alternatively up to 3 weight parts of the silane surfactant on the same basis above. Alternatively, the composition may comprise 0.5 weight part to 5.5 weight parts of the silane surfactant, per up to 100 weight parts of the composition; alternatively 1 weight part to 5.1 weight parts on the same basis.

### (D) Water

The composition further comprises (D) water. The water is not particularly limited, and may be utilized neat (i.e., absent any carrier vehicles/solvents), and/or pure (i.e., free from or substantially free from minerals and/or other impurities). For example, the water may be processed or unprocessed prior to use in the composition and method for preparing it described herein. Examples of processes that may be used for purifying the water include distilling, filtering, deionizing, and combinations of two or more thereof, such that the water may be deionized, distilled, and/or filtered. Alternatively, the water may be unprocessed (e.g. may be tap water, i.e., provided by a municipal water system or well water, used without further purification).

Alternatively, the water may further comprise dissolved species. For example, the water may comprise sea water, which comprises dissolved ions. Alternatively, the water may comprise (G) a pH control agent, such as that described below. For example, the water may contain a base sufficient to render the pH of the water of 7 to 10, alternatively 9 to 10. Alternatively, the water may be utilized as a mixture (e.g. solution or suspension) comprising (E) an additional carrier vehicle (e.g. a solvent, diluent, or dispersant) in addition to the water. When used, the carrier vehicle will be selected depending on various factors such as the species selected for (A) the nonionic surfactant, (B) the zwitterionic surfactant, and (C) the silane surfactant, and, if present, any other starting materials in the composition, and the desired end use of the composition.

Examples of solvents include aqueous solvents, water miscible organic solvents, and combinations thereof. Examples of aqueous solvents include water and polar and/or charged (i.e., ionic) solvents miscible with water. Examples of organic solvents include those comprising an alcohol, such as methanol, ethanol, isopropanol, 1-propanol, 2-propanol, butanol, 2-methyl-2-propanol, and n-propanol; a glycol such as ethylene glycol, propylene glycol, a glycol ether, such as propylene glycol methyl ether, dipropylene glycol methyl ether, propylene glycol n-butyl ether, propylene glycol n-propyl ether, and ethylene glycol n-butyl ether.

Alternatively, the composition may comprise a solvent. The solvent may facilitate introduction of certain starting materials into the composition, mixing and/or homogenization of the starting materials. Likewise, the particular solvent will be selected based on the solubility of (C) the silane surfactant and/or other starting materials utilized in the composition, the volatility (i.e., vapor pressure) of the solvent, and the end-use of the composition. The solvent should be sufficient to dissolve (C) the silane surfactant, and any additional starting materials to form a homogenous composition. As will be understood by those of skill in the art, while organic solvents may be utilized in the composition, such organic solvents may be removed before utilizing the composition, or an end-use composition comprising the same, especially if the organic solvents are flammable and the end-use of the composition is for firefighting foam applications.

The amount of water in the composition depends on various factors, including the type and amounts of (A) the nonionic surfactant, (B) the zwitterionic surfactant, (C) the silane surfactant, and whether any additional starting materials are added. However, the amount of water may be up to 98.5 weight parts, per up to 100 weight parts of the composition. Alternatively, the water may be present in an amount of at least 90 weight parts, alternatively at least 91 weight parts, alternatively at least 92 weight parts, per 100 parts by weight of the composition, while at the same time the amount of water may be up to 98.5 weight parts, alternatively up to 98 weight parts, alternatively up to 97 weight parts, and alternatively up to 96 weight parts, on the same basis. Alternatively, the composition may comprise a concentrate containing an amount of water sufficient to form a homogeneous composition but less than 90 weight parts, per 100 weight parts of the composition, and additional water may be added by an end user of the composition.

### (F) Rheology Modifier

The composition may optionally further comprise (F) the rheology modifier. The rheology modifier is not particularly limited, and is generally selected to alter the viscosity, flow property, and/or a foaming property (i.e., foam-forming ability and/or foam stability) of the composition, or an end-use composition (e.g., firefighting foam) comprising the same. As such, the rheology modifier is not particular limited, and may comprise a thickener, stabilizer, viscosity modifier, thixotropic agent, or combinations thereof, which may be selected from natural or synthetic thickening compounds. Alternatively, the rheology modifier may comprise one or more water soluble and/or water compatible thickening compounds (e.g., water-soluble organic polymers).

Examples of compounds suitable for use in or as the rheology modifier include acrylamide copolymers, acrylate copolymers and salts thereof (e.g. sodium polyacrylates), celluloses (e.g. methylcelluloses, methylhydroxypropylcelluloses, hydroxyethylcelluloses, hydroxypropylcelluloses, polypropylhydroxyethylcelluloses, and carboxymethylcelluloses), starches (e.g. starch and hydroxyethylstarch), polyoxyalkylenes (e.g. PEG, PPG, and PEG/PPG copolymers), carbomers, alginates (e.g. sodium alginate), various gums (e.g. arabic gums, cassia gums, carob gums, scleroglucan gums, xanthan gums, gellan gums, rhamsan gums, karaya gums, carrageenan gums, and guar gums), cocamide derivatives (e.g. cocamidopropyl betaines), medium to long-chain alkyl and/or fatty alcohols (e.g. cetearyl alcohol and stearyl alcohol), gelatin, saccharides (e.g. fructose, glucose, and PEG-120 methyl glucose diolate), and combinations thereof.

### (G) pH Control Agent

The composition may further comprise (G) the pH control agent, which may be introduced with the water, as described above, or which may be added separately during the method for making the composition, introduced above and described further, below. The pH control agent is not particular limited, and may comprise or be any compound suitable for modifying or adjusting the pH of the composition and/or maintaining (e.g. regulating) the pH of the composition in a particular range. As such, as will be understood by those of skill in the art, the pH control agent may comprise, alternatively may be a pH modifier (e.g. an acid and/or a base), a pH buffer, or a combination thereof, such as any one or more of those described below.

Examples of acids generally include mineral acids (e.g. hydrochloric acid, phosphoric acid, and sulfuric acid), organic acids (e.g. citric acid), and combinations thereof. Examples of bases generally include alkali metal hydroxides (e.g. sodium hydroxide and potassium hydroxide), carbonates (e.g. alkali metal carbonate salts such as sodium carbonate), phosphates, and combinations thereof.

Alternatively, the pH control agent may comprises a pH buffer. Suitable pH buffers are not particularly limited, and may comprise, alternatively may be, any buffering compound capable of adjusting the pH of the composition and/or maintaining (e.g. regulating) the pH of the composition in a particular range. As will be understood by those of skill in the art, examples of suitable buffers and buffering compounds may overlap with certain pH modifiers, including those described above, due to the overlap in functions between the additives. As such, when both are utilized in or as (G) the pH control agent, the pH buffer and the pH modifier may be independently or collectively selected in view of each other.

Suitable pH buffers may be selected from buffering compounds that include an acid, a base, or a salt (e.g. comprising the conjugate base/acid of an acid/base). Examples of buffering compounds generally include alkali metal hydroxides (e.g. sodium hydroxide and potassium hydroxide), carbonates (e.g. sesquicarbonates, alkali metal carbonate salts such as sodium carbonate), borates, silicates, phosphates, imidazoles, citric acid, sodium citrate, and combinations thereof. Examples of the some pH buffers include citrate buffers, glycerol buffers, borate buffers, phosphate buffers, and combinations thereof (e.g. citric acid-phosphate buffers). As such, some examples of particular buffering compounds suitable for use in or as the pH buffer of the pH control agent include ethylenediaminetetraacetic acids (e.g. disodium EDTA), triethanolamines (e.g. tris(2-hydroxyethyl)amine), citrates and other polycarboxylic acid-based compounds, and combinations thereof.

### (H) Foam Enhancer

The composition may optionally further comprise (H) the foam enhancer. Particular compounds/compositions suitable for use in or as the foam enhancer are not limited, and generally include those capable of imparting, enhancing, and or modifying a foaming property (e.g. foamability, foam stability, foam drainage, foam spreadability, and/or foam density) of the composition, or an end-use composition comprising the same.

For example, the foam enhancer may comprise a stabilizing agent selected from electrolytes (e.g. alkali metal and/or alkaline earth salts of various anions, such as chloride, borate, citrate, and/or sulfate salts of sodium, potassium, calcium, and/or magnesium, and aluminum chlorohydrates), polyelectrolytes (e.g. hyaluronic acid salts, such as sodium hyaluronates), polyols (e.g. glycerine, propylene glycols, butylene glycols, and sorbitols), hydrocolloids, and combinations thereof.

Alternatively, the foam enhancer may comprise a saccharide compound, i.e., a compound comprising at least one saccharide moiety. It is to be appreciated that the term “saccharide” may be used synonymously with the term “carbohydrate” under general circumstances, and terms like “sugar” under more specific circumstances. As such, the nomenclature of any particular saccharide is not exclusionary with regard to suitable saccharide compounds for use in or as the foam enhancer. Rather, as will be understood by those of skill in the art, suitable saccharide compounds may include, alternatively may be, any compound comprising a moiety that can be described as a saccharide, carbohydrate, sugar, starch, cellulose, or a combination thereof. Likewise, any combination of more than one saccharide moiety in the saccharide compounds may be described in more descriptive terms. For example, the term “polysaccharide” may be used synonymously with the term “glycoside,” where both terms generally refer to a combination of more than one saccharide moiety (e.g. where the combination of saccharide moieties are linked together via a glycosidic linkage and collectively form a glycoside moiety). One of skill in the art will appreciate that terms such as “starch” and “cellulose” may be used to refer to such combinations of saccharide moieties under specific circumstances (e.g. when a combination of more than one saccharide moiety in the saccharide compound conforms to the structure known in the art as a “starch” or a “cellulose”).

Examples of saccharide compounds suitable for use in or as the foam enhancer may include compounds, or compounds comprising at least one moiety, conventionally referred to as a monosaccharide and/or sugar (e.g. pentoses (i.e., furanoses), such as riboses, xyloses, arabinoses, lyxoses, fructoses, and hexoses (i.e., pyranoses), such as glucoses, galactoses, mannoses, guloses, idoses, taloses, alloses, and altroses), a disaccharide (e.g. sucroses, lactoses, maltoses, and trehaloses), an oligosaccharide (e.g. malto-oligosaccharides, such as maltodextrins, arafinoses, stachyoses, and fructooligosaccharides), a polysaccharide (e.g. celluloses, hemicelluloses, pectins, glycogens, hydrocolloids, starches such as amyloses, and amylopectins), or a combination thereof.

Other examples of foam enhancers suitable for use in or as starting material (H) are known in the art. For example, the foam enhancer may comprise a polymeric stabilizer, such as those comprising a polyacrylic acid salt, a modified starch, a partially hydrolyzed protein, a polyethyleneimine, a polyvinyl resin, a polyvinyl alcohol, a polyacrylamides, a carboxyvinyl polymer, a fatty acid such as myristic acid or palmitic acid, or combinations thereof. Alternatively, the foam enhancer may comprise a thickener, such as those comprising one or more gums (e.g. xanthan gum), collagen, galactomannans, starches, starch derivatives and/or hydrolyzates, cellulose derivatives (e.g. methyl cellulose, hydroxypropylcellulose, hydroxyethyl cellulose, and hydroxypropyl methyl cellulose), polyvinyl alcohols, vinylpyrrolidone-vinylacetate-copolymers, polyethylene glycols, polypropylene glycols, or a combination thereof. Alternatively, the foam enhancer may comprise 1,2,3-propanetriol. Foam enhancers are commercially available, e.g., from Fisher Scientific.

The composition may comprise one or more additional starting materials, i.e., other than those described above, which are known in the art and will be selected based on the particular starting materials utilized in the composition and a desired end-use thereof. For example, the composition may comprise: a filler; a filler treating agent; a surface modifier; a binder; a compatibilizer; a colorant (e.g. a pigment or dye); an anti-aging additive; a flame retardant; a corrosion inhibitor; a UV absorber; an anti-oxidant; a light-stabilizer; a heat stabilizer; and combinations thereof. However, the composition described above may be free of perfluoroalkyl surfactants. Alternatively, the composition may be free of perfluoroalkyl substances.

When selecting starting materials for the composition, one skilled in the art will readily appreciate that certain starting materials may have more than one function. For example, certain zwitterionic surfactants may also be rheology modifiers (e.g., cocamidopropyl betaines). Furthermore, compounds/compositions suitable for use in or as the foam enhancer may overlap with those described herein with respect to other additives/starting materials of the composition. When adding additional starting materials to the composition, the starting materials of the composition are distinct from one another.

### Method of Making the Composition

The composition described above is prepared by a method comprising:
(1) combining
   at least 0.5 weight part of starting material (A), the a nonionic surfactant described above; and
   at least 0.5 weight part of starting material (B), the zwitterionic surfactant described above, thereby forming a surfactant mixture;
(2) mixing and heating, at a temperature of 60° C. to <100° C., the surfactant mixture and at least 0.5 weight part of starting material (C), the silane surfactant described above, thereby forming a homogeneous solution; and thereafter
(3) combining the homogeneous solution and up to 98.5 weight parts of starting materials (D) water. The method may optionally further comprise step (4): adding an additional starting material after step (1), after step (2), and/or during step (3). The additional starting material is as described above, e.g., the additional starting material may be selected from the group consisting of (E) the carrier vehicle other than water, (F) the rheology modifier, (G) the pH control agent, (H) the foam enhancer, and the combination of two or more of (E) to (H).

Combining in step (1) may be performed by any convenient means using conventional equipment. Combining may be performed by mixing optionally under high shear. Mixing may occur, for example using, batch mixing equipment with medium/low shear include change-can mixers, double-planetary mixers, conical-screw mixers, ribbon blenders, double-arm or sigma-blade mixers; batch equipment with high-shear and high-speed dispersers include those made by Charles Ross & Sons (NY), Hockmeyer Equipment Corp. (NJ); batch mixing equipment such as mixers sold under the tradename Speedmixer™; batch equipment with high shear action include Banbury-type (CW Brabender Instruments Inc., NJ) and Henschel type (Henschel mixers America, TX). Illustrative examples of continuous mixers/compounders include extruders, include single-screw, twin-screw, and multi-screw extruders, co-rotating extruders, such as those manufactured by Krupp Werner & Pfleiderer Corp (Ramsey, NJ), and Leistritz (NJ); twin-screw counter-rotating extruders, two-stage extruders, twin-rotor continuous mixers, dynamic or static mixers or combinations of these equipment. Alternatively, step (1) may be performed using a mixer of the rotor and stator type or in equipment applying increased shear such as a high pressure homogenizer, microfluidizer, colloid mill, or sonolator (ultrasonic mixer). Alternatively, step (1) may be performed by subjecting (A) the nonionic surfactant and (B) the zwitterionic surfactant to high shear. Combining in step (1) may be at RT or elevated temperature, e.g., 60° C. to <100° C.

Step (2) comprises mixing and heating the surfactant mixture formed in step (1) and (C) the silane surfactant. Heating may be performed at a temperature 60° C. to <100° C. Without wishing to be bound by theory, it is thought that a homogeneous solution will not form in a reasonable amount of time without heating in step (2). The solution formed in step (2) was considered to be a homogenous solution when, by visual inspection, no silane-surfactant solids were visible in the solution. Furthermore, step (2) may be performed in the same equipment as described above for step (1), e.g., any of the equipment described above that provides high shear. Alternatively, step (1) and step (2) may be performed in the same piece of equipment.

Step (3) of the method described above comprises combining the homogeneous solution formed in step (2) and water. Water may be added in one or more portions in step (3). For example, step (3) may comprise adding all of the water to a balance of 100 weight parts of the composition, and mixing using the same equipment described above for step (2). Alternatively, step (3) may comprise adding 5 weight parts to 25 weight parts of the water, (per 100 parts by weight of the composition) and mixing. During or after step (3), the balance of the water to the amounts described above may be added. (For example, the foam stabilizing composition may be formed as a concentrate comprising the amounts above of starting materials (A), (B), and (C); and optionally one or more of (E) to (H); and an amount of (D) water less than that needed to make 100 weight parts of the composition.) Alternatively, during step (3), the foam stabilizing composition comprising the amounts above of starting materials (A), (B), and (C); and optionally one or more of (E) to (H); and an amount of water sufficient to provide 100 weight parts of the composition may be formed.

The method described above may optionally further comprise adding >0 to 15 weight parts of the water after step (1) and before step (2). In this instance, a balance of 83.5 to <98.5 weight parts of water may be added in step (3). Alternatively, >0 to 5 weight parts of the water may be added in this optional additional method step. Without wishing to be bound by theory, it is thought that adding more than 15 weight parts of the water before step (2) may be detrimental to the performance of the foam stabilizing composition, however, adding a portion of the water (up to 15 weight parts, per 100 weight parts of the composition) may facilitate formation of the homogenous solution in step (2).

### Method of Use

The composition described above may be formulated as a foam-forming composition (e.g. via subjecting the composition to conditions to form a foam). Alternatively, the foam stabilizing composition including starting materials (A), (B), (C), and (D) may be subsequently combined with one or more of the additional starting materials, such as the rheology modifier and/or the foam enhancer, to form the foam-forming composition comprising the foam stabilizing composition.

Alternatively, the method described above may be used to form the homogeneous solution, e.g., after step (2), the homogeneous solution may comprise at least 0.5 weight parts of (A) the nonionic surfactant, at least 0.5 weight parts of (B) the zwitterionic surfactant, at least 0.5 weight parts of (C) the silane surfactant, and 0 to 15 weight parts of (D) the water. This homogeneous solution may then be combined with the balance of the water and optionally one or more additional starting materials, as described above, to form the foam-forming composition.

The foam prepared with the foam stabilizing composition and/or the foam-forming composition is suitable for use in various applications. For example, as introduced above, the composition may be utilized in firefighting applications, e.g., extinguishing, suppressing, and/or preventing fire. In particular, due to the increased stability provided by the composition, foams prepared therewith may be used for extinguishing fires involving chemicals with low boiling points, high vapor pressures, and/or limited aqueous solubility (e.g. gasoline and/or organic solvents), which are typically extremely flammable and/or difficult to extinguish and/or prevent reignition. For example, such a fire may be extinguished by contacting the fire and/or the fuel for the fire with the foam (e.g. by spraying the foam onto the fire or spraying the foam-forming composition over the fire to prepare the foam thereon). In similar fashion, the foam may be utilized to secure chemicals (e.g. from a spill or leak thereof) to limit vapor leak and/or ignition, by the applying the foam to the top of the spill/leak, or otherwise forming the foam thereon.

The foam-forming composition, once prepared, may be aerated or otherwise expanded (e.g. via foaming equipment or application to an aerated water stream/flow) to form a foam composition (i.e., a “foam”). Alternatively, the foams may be produced by mechanically agitating or submitting to other conventional foam-producing methods an aqueous mixture having the same composition as the final foam. The finished foam may then be dispensed upon a polar fuel and/or a hydrocarbon fuel fire.

### EXAMPLES

These examples are intended to illustrate the invention to one skilled in the art and are not to be construed as limiting the scope of the invention set forth in the appended claims. Starting materials used in these examples are described below in Table 1.

TABLE 1
Starting Materials

| Ingredient Type | Product Name | Chemical Name/INCI Name | Source |
|---|---|---|---|
| Surfactant | Cocoamidopropylbetaine | Cocoamidopropylbetaine | Makeyourown.buzz |
| 1 (zwitterionic) | | | |
| Surfactant 2 | EcoSense ™ 3000 | Decyl Glucoside | TDCC |
| | Surfactant | | |
| Surfactant 3 | Stepan Steol CS-130 | Sodium Lauryl Ether | Stepan Company |
| | | Sulfate | |
| Surfactant 4 | Stepan Steol CA-330 | Ammonium Lauryl | Stepan Company |
| | | Ether Sulfate | |
| Surfactant 5 | Ninol 30-LL | Lauramide DEA | Stepan Company |
| Silane | DOWSIL ™ 2501 Cosmetic | Bis-PEG-18 Methyl Ether | DSC |
| Surfactant | Wax | Dimethyl Silane | |
| Foam Enhancer | Glycerol | 1,2,3-propanetriol | Fisher Scientific |
| 1 | | | |
| pH Control | Citric Acid (99%) diluted in | Citric Acid | Sigma Aldrich |
| Agent | water to 50% | | |
| Diluent | DI Water | H₂O | TDCC |
| Test Fuel | Heptane | Heptane | Sigma Aldrich |

In this Reference Example 1, samples were prepared by:
(1) mixing Surfactant 1 and Surfactant 2 for 30 seconds at 3500 rpm using a dental mixer,
(2) mixing the product formed in step (1) and a Silane Surfactant for 30 seconds at 3500 rpm while heating at 60° C. in an oven,
(3) mixing a first portion of the Diluent and the product formed in step (2) for 30 seconds at 3500 rpm,
(4) mixing a second portion of the Diluent and the product formed in step (3) for 30 seconds at 3500 rpm. Amounts of each starting material in the sample prepared according to the method in Reference Example 1, IE1, are shown below in Table 2.

In this Example 2, sample IE2 was prepared as follows: To a 500 mL glass sample jar 1.68 grams of surfactant 1 and 1.00 grams of surfactant 2 were added and placed in a 60° C. water bath. The solution was mixed using a magnetic stir bar. Then 1.01 grams of the silane surfactant was added to the solution and mixed (˜10-15 minutes). The silane surfactant was completely dissolved in the solution. Once dissolved 22.75 grams of diluent was added and mixed for ˜10 minutes. Another 74.01 grams of diluent was added and mixed for ˜ 10 minutes. The solution was removed from the water bath and allowed to cool to room temperature. Amounts of each starting material in the sample IE2 are shown below in Table 2.

In this Reference Example 3, samples were prepared by:
(i) mixing Surfactant 1 and Surfactant 2 for 30 seconds at 3500 rpm in a dental mixer cup using a dental mixer,
(ii) mixing the product formed in step (i) and a first portion of the Diluent for 30 seconds at 3500 rpm,
(iii) combining the product formed in step (ii) and a Silane Surfactant without mixing while heating at 60° C. using by placing the dental mixer cup on a hot plate, and when the Silane Surfactant melted, mixing for 30 seconds at 3500 rpm until the Silane Surfactant dissolved,
(iv) mixing foam enhancer 1 and the product formed in (iii)
(v) mixing a second portion of the diluent and the product formed in step (iv) for 30 seconds at 3500 rpm,
(vi) mixing a third portion of the diluent and the product formed in step (v) for 30 seconds at 3500 rpm. Amounts of each starting material in the samples prepared according to the method in Reference Example 3, IE3, IE4, IE5, IE6, and IE8 are shown below in Table 2.

In this Reference Example A, samples were prepared by:
(1) mixing Surfactant 1 and Surfactant 2 for 30 seconds at 3500 rpm in a dental mixer cup using a dental mixer,
(2) combining the product formed in step (1) and a Silane Surfactant without mixing while heating at 60° C. using by placing the dental mixer cup on a hot plate, and when the Silane Surfactant melted, mixing for 30 seconds at 3500 rpm,
(3) mixing a first portion of the Diluent and the product formed in step (2) for 30 seconds at 3500 rpm,
(4) mixing a second portion of the Diluent and the product formed in step (3) for 30 seconds at 3500 rpm. Amounts of each starting material in the samples prepared according to the method in Reference Example A, IE7, CE1, and CE2, are shown below in Table 2. In preparing samples CE1 and CE2, the silane surfactant did not completely dissolve before the first portion of the Diluent was added in step (3), so no homogeneous solution formed in step (2). In preparing sample IE7, the Silane Surfactant dissolved before step (3), therefore a homogeneous solution formed in step (2).

In this Reference Example B, samples were prepared by:
(i) mixing Surfactant 1, Surfactant 2, Silane Surfactant and a first portion of Diluent in a jar, where the jar was placed in a water bath at 60° C., until the Silane Surfactant dissolved,
(ii) mixing a second portion of the Diluent and the product formed in step (1), and
(iii) cooling the resulting foam stabilizing composition to room temperature. Amounts of each starting material in the sample CE3 prepared according to the method in this Reference Example B are shown below in Table 2.

In this Comparative Example 4, sample CE4 was prepared as follows: To a glass sample jar 38.48 grams of diluent was added and placed in a 70° C. water bath. The water was mixed at 200 rpms during the addition of the surfactants. The mixing speed had to be adjusted on the addition of certain surfactants due to the higher viscosity of the solution. The speed would be lowered and then increased back up to 200 rpms as the surfactant became soluble in the diluent. The additional additives were added and mixed in the following order: surfactant 3 (22.05 g), surfactant 4 (18.06 g), surfactant 1 (9.99 g), surfactant 5 (6.13 g), pH control agent (1.03 g), and silane surfactant (5.09 g). The solution was then removed from the water bath and allowed to cool to room temperature. The solution was too viscous to produce a foam, so the solution was diluted to 0.5% silane surfactant by adding 10.09 grams of the above solution and diluting it to 100.12 grams in diluent. The diluted solution generated a significant amount of foam and was used to test foam stability.

In this Comparative Example 5, sample CE5 was prepared as follows: To a dental mixer cup 1.67 grams of surfactant 1 and 1.04 grams of surfactant 2 were added and mixed for 30 seconds at 3500 rpms using a dental mixer. Then 1.00 grams of the silane surfactant was added to the solution and mixed at 3500 rpms for 120 seconds. The silane surfactant was not completely dissolved in the solution, so an extra 12.78 g of diluent was added and mixed for 30 seconds at 3500 rpms. The silane surfactant was then completely dissolved. To the solution 11.39 grams of diluent was added and mixed for 30 seconds at 3500 rpms. An additional 72.13 grams of diluent was added and mixed for 60 seconds at 3500 rpms.

In this Comparative Example 6, sample CE6 was prepared as follows: To a glass sample jar 3.33 grams of surfactant 1, 1.00 grams of surfactant 2, and 95.67 grams of diluent was added. The solution was mixed at room temperature using a magnetic stir bar for ˜5 minutes.

TABLE 2
Sample Preparation

| Starting Material | | | | | | | | |
|---|---|---|---|---|---|---|---|---|
| (weight parts) | IE1 | IE2 | IE3 | IE4 | IE5 | IE6 | IE7 | IE8 |
| Surfactant 1 | 1.7 | 1.68 | 1.67 | 1.68 | 1.69 | 1.69 | 1.69 | 1.67 |
| Surfactant 2 | 1.08 | 1 | 1.03 | 1.01 | 1 | 1.02 | 1 | 1.02 |
| Silane | 1.09 | 1.01 | 1 | 1.02 | 1.06 | 5.05 | 3 | 1.01 |
| Surfactant | | | | | | | | |
| Solvent 1 | 0 | 0 | 0 | 0 | 0 | 0 | 0 | .50 |
| First Diluent | 22.22 | 22.75 | 5.03 | 10.05 | 15.02 | 5.00 | 22.79 | 5.02 |
| Addition | | | | | | | | |
| Second Diluent | 74.06 | 74.01 | 22.77 | 22.80 | 22.76 | 23.30 | 71.91 | 22.83 |
| Addition | | | | | | | | |
| Third Diluent | 0.00 | 0.00 | 68.80 | 64.19 | 58.58 | 64.20 | 0.00 | 68.21 |
| Addition | | | | | | | | |
| Total Diluent | 96.28 | 96.76 | 96.4 | 97.04 | 96.36 | 92.5 | 94.7 | 96.06 |
| Total Starting | 100.15 | 100.45 | 100.1 | 100.75 | 100.11 | 100.26 | 100.39 | 100.26 |
| Materials | | | | | | | | |

Calculated Weight %

| | | | | | | | | |
|---|---|---|---|---|---|---|---|---|
| % Surfactant 1 | 1.70% | 1.67% | 1.67% | 1.67% | 1.69% | 1.69% | 1.68% | 1.67% |
| % Surfactant 2 | 1.08% | 1.00% | 1.03% | 1.00% | 1.00% | 1.02% | 1.00% | 1.02% |
| % Silane | 1.09% | 1.01% | 1.00% | 1.01% | 1.06% | 5.04% | 2.99% | 1.01% |
| Surfactant | | | | | | | | |
| Solvent 1 | 0.00% | 0.00% | 0.00% | 0.00% | 0.00% | 0.00% | 0.00% | 0.50% |
| % Diluent | 96.14% | 96.33% | 96.30% | 96.32% | 96.25% | 92.26% | 94.33% | 95.81 |

| Starting Material | | | | | | |
|---|---|---|---|---|---|---|
| (weight parts) | CE1 | CE2 | CE3 | CE4 | CE5 | CE6 |
| Surfactant 1 | 1.68 | 1.7 | 1.68 | 9.99 | 1.67 | 3.33 |
| Surfactant 2 | 1.05 | 1.03 | 1.01 | 0 | 1.04 | 1 |
| Surfactant 3 (comp) | 0 | 0 | 0 | 22.05 | 0 | 0 |
| Surfactant 4 (comp) | 0 | 0 | 0 | 18.06 | 0 | 0 |
| Surfactant 5 (comp) | 0 | 0 | 0 | 6.13 | 0 | 0 |
| Silane Surfactant | 4.98 | 1 | 1.01 | 5.09 | 1 | 0 |
| pH control agent | 0 | 0 | 0 | 1.03 | 0 | 0 |
| First Diluent Addition | 22.90 | 21.48 | 26.34 | 38.48 | 12.78 | 95.67 |
| Second Diluent Addition | 69.60 | 74.85 | 70.00 | 0.00 | 11.39 | 0.00 |
| Third Diluent Addition | 0.00 | 0.00 | 0.00 | 0.00 | 72.13 | 0.00 |
| Total Diluent | 92.5 | 74.85 | 96.34 | 38.48 | 96.3 | 95.67 |
| Total Starting Materials | 100.21 | 78.58 | 100.04 | 100.83 | 100.01 | 100 |

Calculated Weight %

| | | | | | | |
|---|---|---|---|---|---|---|
| % Surfactant 1 | 1.68% | 2.16% | 1.68% | 9.91% | 1.67% | 3.33% |
| % Surfactant 2 | 1.05% | 1.31% | 1.01% | 0.00% | 1.04% | 1.00% |
| % Silane Surfactant | 4.97% | 1.27% | 1.01% | 5.05% | 1.00% | 0.00% |
| % Diluent | 92.31% | 95.25% | 96.30% | | 96.29% | 95.67% |

In this Reference Example 7, household foaming soap dispensers purchased on Amazon (Parker Eight, 10 oz) were used to generate foams using the samples described above. For foam stability measurements on hot heptane, a flat-bottom crystallizing dish with a diameter of 100 mm and height of 50 mm was used. A digital camera (Canon Rebel T3i) with an 18-55 mm lens was used to capture images of the foams from the side of the container at fixed time intervals to visualize the dynamics of foam collapse. The light source, focus, aperture, and shutter speed were adjusted manually according to needs. 40 ml of heptane was first poured into the dish. The dish was heated on a hot plate to allow heptane to reach 60° C. and maintained at that temperature. Then 100 ml of foam was dispensed on top of the hot heptane and the hot plate was subsequently switched off. Image series was recorded at 1 frame every 2 seconds. The recorded images were imported in ImageJ image analysis software. “Line tool” in ImageJ was used to calculate the foam height in each image of the image series. Foam height at time=0 (first image) was subtracted from the heights measured in subsequent images to calculate the % change in foam height as a function of time. The time was stopped and recorded once the foam had been completely destroyed over the heptane fuel. Results are shown below in Table 3.

TABLE 3
Foam stability over 60° C. heptane

| Tested | Performance | | | | | | | | |
|---|---|---|---|---|---|---|---|---|---|
| Property | Criteria | IE1 | IE2 | IE3 | IE4 | IE5 | IE6 | IE7 | IE8 |
| Foam | >12 | 20 | 17 | 21 | 15 | 13 | 12 | 19 | 16 |
| Stability | minutes | minutes | minutes | minutes | minutes | minutes | minutes | minutes | minutes |
| on 60° C. | | 0 | 40 | 8 | 36 | 0 | 15 | 00 | 58 |
| Heptane | | seconds | seconds | seconds | seconds | seconds | seconds | seconds | seconds |

| Tested | Performance | | | | | | |
|---|---|---|---|---|---|---|---|
| Property | Criteria | CE1 | CE2 | CE3 | CE4 | CE5 | CE6 |
| Foam | >12 | 8 | 11 | 4 | 0 | 8 | 10 |
| Stability | minutes | minutes | minutes | minutes | minutes | minutes | minutes |
| on 60° C. | | 56 | 52 | 28 | 36 | | 30 |
| Heptane | | seconds | seconds | seconds | seconds | | seconds |

Sample CE6 showed that exclusion of the silane surfactant from the foam stabilizing composition yielded a foam with poor foam stability under the conditions tested. Sample CE4 was prepared according to U.S. Pat. No. 5,723,111, and had inferior foam stability to the compositions prepared by the method of this invention (all of IE1 to IE8).

The data in Table 3 also show that even with the same starting materials, the foam stability performance can differ significantly due to the process and order of addition used to produce the composition. Without wishing to be bound by theory, it is thought that to achieve the desired performance of >12 minute foam stability on 60 C heptane (measured as described in Reference Example 7), the silane surfactant is added with as little water as possible while ensuring that the surfactants form a homogeneous solution before adding additional water to form the foam stabilizing composition.

For example, sample CE3 and sample IE3 show that a foam stabilizing composition produced by adding all starting materials concurrently yielded a foam with inferior stability (i.e., in CE3) to a foam prepared from a composition prepared by the method of this invention (i.e., in IE3), in which the order of addition specified in claim 1, below, was used. Sample CE5 also shows that producing a composition with a method that fails to form a homogeneous solution of the surfactants (as recited in step (2) of the method of claim 1) yielded a foam with inferior stability as compared to sample IE1 and sample IE2 under the conditions tested.

### Definitions and Usage of Terms

All amounts, concentrations, ratios, and percentages are by weight unless otherwise indicated. The SUMMARY and ABSTRACT are hereby incorporated by reference. The articles ‘a’, ‘an’, and ‘the’ each refer to one or more, unless otherwise indicated. The singular includes the plural unless otherwise indicated. Abbreviations are defined below in Table 6.

TABLE 6
Abbreviations

| Abbreviation | Definition |
|---|---|
| AFFF | aqueous film forming foam |
| BCF | tris(pentafluorophenyl)borane |
| ° C. | degrees Celsius |
| CTAC | cetrimonium chloride |
| DI | deionized |
| DSC | Dow Silicones Corporation of Midland, Michigan, USA |
| g | gram |
| ¹H NMR | Proton nuclear magnetic resonance tested as described |
| | below |
| IPA | isopropanol |
| mL or ml | milliliter |
| mm | millimeter |
| mmHg | millimeter of mercury |
| nm | nanometer |
| oz | ounce |
| PEG | polyethylene glycol |
| PFAS | perfluoroalkyl substances |
| PPG | polypropylene glycol |
| ppm | parts per million |
| RPM | revolutions per minute |
| RT | Room temperature of 23° C. ± 2° C. |
| SPE | Silicone polyether |
| TDCC | The Dow Chemical Company of Midland, Michigan, USA |

### EMBODIMENTS OF THE INVENTION

In a first embodiment, a firefighting method comprises:
(I) making a foam stabilizing composition by a method comprising:
   (1) combining
      at least 0.5 weight part starting material (A), a nonionic surfactant; and
      at least 0.5 weight part of starting material (B), a zwitterionic surfactant, thereby forming a surfactant mixture;
   (2) mixing and heating at a temperature of 60° C. to <100° C., the surfactant mixture and at least 0.5 weight part of starting material (C), a silane surfactant of formula

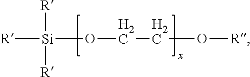

where subscript x is an integer with an average value of 1 to 30; R″ is an alkyl group of 1 to 6 carbon atoms or an aryl group of 6 to 20 carbon atoms, and each R′ is independently selected from the group consisting of an alkyl group of 1 to 6 carbon atoms or a group of formula

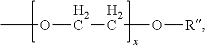

where x and R″ are as described above, under conditions to form a homogeneous solution; and thereafter
(3) combining the homogeneous solution and up to 98.5 weight parts of starting materials (D) water;
(II) forming a foam from the foam stabilizing composition; and
(III) dispensing the foam on a fuel.

In a second embodiment, the method of the first embodiment further comprises adding >0 to 15 weight parts of (D) the water after step (1) and before step (2), and adding a balance of 83.5 to <98.5 weight parts of water in step (3).

In a third embodiment, the method of the first embodiment or the second embodiment further comprises: (4) adding an additional starting material to the foam stabilizing composition after step (1), after step (2), and/or during step (3).

In a fourth embodiment, in the method of the third embodiment, the additional starting material is selected from the group consisting of a carrier vehicle other than water, a rheology modifier, a pH control agent, a foam enhancer, and a combination thereof.

In a fifth embodiment, in the method of the first embodiment, step (3) comprises adding water in two or more portions, provided that the water is added in a total amount ≤98.5 weight parts, per 100 weight parts of the foam stabilizing composition.

In a sixth embodiment, in the method of any one of the first to fifth embodiments, (A) the nonionic surfactant comprises an alkyl glucoside.

In a seventh embodiment, in the method of any one of the first to sixth embodiments amount of (A) the nonionic surfactant is 0.5 weight part to 2 weight parts, per 100 weight parts of the foam stabilizing composition.

In an eighth embodiment, in the method of any one of the first to seventh embodiments, (B) the zwitterionic surfactant comprises a betaine.

In a ninth embodiment, in the method of any one of the first to eighth embodiments, amount of (B) the zwitterionic surfactant is 1.0 weight part to 1.5 weight parts, per 100 weight parts of the foam stabilizing composition.

In a tenth embodiment, in the method of any one of the first to ninth embodiments (C) the silane surfactant has formula

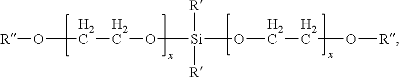

where each subscript x is independently an integer with an average value of 1 to 30; each R″ is independently selected from the group consisting of an alkyl group of 1 to 6 carbon atoms and an aryl group of 6 to 20 carbon atoms, and each R′ is an independently selected alkyl group of 1 to 6 carbon atoms.

In an eleventh embodiment, in the method of the tenth embodiment, each subscript x is independently 10 to 12 or 22 to 24; each R″ is methyl, and each R′ is methyl.

In a twelfth embodiment, in the method of any one of the first to eleventh embodiments amount of (C) the silane surfactant is 1.0 weight parts to 5.5 weight parts, per 100 weight parts of the foam stabilizing composition.

In a thirteenth embodiment, in the method of any one of the first to twelfth embodiments, the fuel is on fire in step (III). (In this embodiment, the method is used for fire extinguishment and/or to prevent reignition.)

In a fourteenth embodiment, in the method of any one of the first to twelfth embodiments, the fuel is not on fire in step (III). (In this embodiment, the method is used for fire prevention.

In a fifteenth embodiment, in the method of any one of the first to fourteenth embodiments, the water used for preparing the foam stabilizing composition and/or the foam is sea water.

In a sixteenth embodiment, the method of the fifteenth embodiment further comprises storing the foam stabilizing composition in a shipboard or shore fire suppression system.

1.-15. (canceled)

16. A firefighting method comprises:
(I) making a foam stabilizing composition by a method comprising:
(1) combining
at least 0.5 weight part starting material (A), a nonionic surfactant; and
at least 0.5 weight part of starting material (B), a zwitterionic surfactant, thereby forming a surfactant mixture;
(2) mixing and heating at a temperature of 60° C. to <100° C., the surfactant mixture and at least 0.5 weight part of starting material (C), a silane surfactant of formula 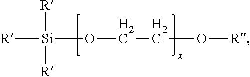
where
subscript x is an integer with an average value of 1 to 30;
R″ is an alkyl group of 1 to 6 carbon atoms or an aryl group of 6 to 20 carbon atoms; and
each R′ is independently selected from the group consisting of an alkyl group of 1 to 6 carbon atoms or a group of formula 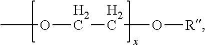
where x and R″ are as described above, under conditions to form a homogeneous solution; and thereafter
(3) combining the homogeneous solution and up to 98.5 weight parts of starting materials (D) water;
(II) forming a foam from the foam stabilizing composition; and
(III) dispensing the foam on a fuel.

17. The method of claim 16, further comprising: adding >0 to 15 weight parts of (D) the water after step (1) and before step (2), and adding a balance of 83.5 to <98.5 weight parts of water in step (3).

18. The method of claim 16, further comprising: (4) adding an additional starting material to the foam stabilizing composition after step (1), after step (2), and/or during step (3).

19. The method of claim 18, where the additional starting material is selected from the group consisting of a carrier vehicle other than water, a rheology modifier, a pH control agent, a foam enhancer, and a combination thereof.

20. The method of claim 16, where step (3) comprises adding water in two or more portions, provided that the water is added in a total amount ≤98.5 weight parts, per 100 weight parts of the foam stabilizing composition.

21. The method of claim 16, where (A) the nonionic surfactant comprises an alkyl glucoside.

22. The method of claim 16, where amount of (A) the nonionic surfactant is 0.5 weight part to 2 weight parts, per 100 weight parts of the foam stabilizing composition.

23. The method of claim 16, where (B) the zwitterionic surfactant comprises a betaine.

24. The method of claim 16, where amount of (B) the zwitterionic surfactant is 1.0 weight part to 1.5 weight parts, per 100 weight parts of the foam stabilizing composition.

25. The method of claim 16, where (C) the silane surfactant has formula 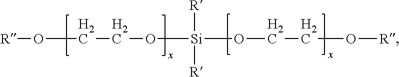
where each subscript x is independently an integer with an average value of 1 to 30; each R″ is independently selected from the group consisting of an alkyl group of 1 to 6 carbon atoms and an aryl group of 6 to 20 carbon atoms, and each R′ is an independently selected alkyl group of 1 to 6 carbon atoms.

26. The method of claim 25, where each subscript x is independently 10 to 12 or 22 to 24; each R″ is methyl, and each R′ is methyl.

27. The method of claim 16, where amount of (C) the silane surfactant is 1.0 weight parts to 5.5 weight parts, per 100 weight parts of the foam stabilizing composition.

28. The method of claim 16, where the fuel is on fire in step (III).

29. The method of claim 16, where the fuel is not on fire in step (III).

30. The method of claim 16, where the water used for preparing the foam stabilizing composition and/or the foam is sea water.

31. The method of claim 30, where further comprising storing the foam stabilizing composition in a shipboard or shore fire suppression system.
